(19) United States
(12) Patent Application Publication
(10) Pub. No.: US 2026/0079956 A1
(43) Pub. Date: Mar. 19, 2026

(54) DATA LIFE CYCLE TEMPLATIZATION ENGINE AND FRAMEWORK

(71) Applicant: Neuralix Inc., Houston, TX (US)

(72) Inventors: Vikram Jayaram, Dallas, TX (US); Saaksshi Milind Jilhewar, Gainesville, FL (US); Ryan Matthew Mercer, Loma Linda, CA (US)

(73) Assignee: Neuralix Inc., Houston, TX (US)

(21) Appl. No.: 19/313,577

(22) Filed: Aug. 28, 2025

Related U.S. Application Data
(60) Provisional application No. 63/694,861, filed on Sep. 15, 2024.

(51) Int. Cl. G06F 16/25; G06F 16/21; G06F 16/28

(52) U.S. Cl. CPC G06F 16/254; G06F 16/211; G06F 16/219; G06F 16/287

(57) ABSTRACT

A Data Life Cycle Templatization (DLT) engine and framework which is a plugin-based architecture that allows for a lightweight, modular approach to data management. The DLT framework operates as a lightweight library and by providing pre-built solutions that can be rapidly adapted to specific use cases, the DLT engine eliminates the need for extensive engineering and data science resources for a client. In one embodiment, a DLT engine and framework incorporates DataOPS methodologies and AI algorithms including machine learning, predictive analytics, and LLM-based user interfaces to transform maintenance strategies, optimize supply chains, and modernize data ecosystems.

### CROSS-REFERENCE TO RELATED APPLICATIONS

This patent application claims the benefit of U.S. Provisional Application Ser. No. 63/694,861 filed Sep. 15, 2024, the contents of which are incorporated by reference herein.

### BACKGROUND OF THE INVENTION

The inventive concepts relate to the field of data science lifecycle and, in particular, to data life cycle. More particularly, the inventive concepts relate to a system and method for templatization of entire data lifecycle and deployment of enterprise Artificial Intelligence (AI) solutions.

Data science is the study of large amounts of data to find and extract meaningful insights for organizations/businesses. It's a multidisciplinary approach that combines principles from computer engineering, mathematics, statistics, scientific methods and visualization, and artificial intelligence to analyze large amounts of structured or unstructured data to extract or extrapolate insights and/or knowledge that may help organizations understand why events happen and make better decisions.

Data science life cycle is an iterative set of data science steps taken to deliver a project or analysis and involves the use of machine learning and different analytical strategies to produce meaningful insights. Data science lifecycle may include the following: (1) understanding the business problem; (2) preparing the data-data mining, data cleaning; (3) exploratory data analysis; (4) feature engineering (5) modeling the data or predictive modeling; (6) evaluating the model; and (7) deploying the model.

A data lifecycle illustrates how data in various forms and derivatives—data points, datasets, databases, data files, visualizations, and code—conceptually flows through its lifecycle of usefulness. The data lifecycle may be split into eight common phases: (1) generation (2) collection (3) processing (4) storage (5) management (6) analysis (7) visualization (8) interpretation. Data life cycle maybe considered as a superset of data science lifecycle additionally including monitoring underlying data sources, visualizing and alerting.

Current systems and solutions in the marketplace offer solutions including managing data science lifecycle (for example, Databricks, Vertex AI, Sage maker, Snowflake), managing monitoring aspects of the data science lifecycle (for example, Grafana, Streamlit, SEEQ), and end-to-end solution suites (for example, C3.ai, Palantir, AVEVA, Microsoft Power Platform). U.S. Pat. No. 11,126,635 relates to systems and methods for data processing and enterprise AI applications. However, these existing solutions do not provide a data lifecycle tool capable of covering most use cases in a rapidly developable manner.

The increasing complexity and scale of data management, particularly in enterprise environments, necessitate a standardized, scalable, and automated approach to data lifecycle management. Traditional pipelines often involve significant manual effort, leading to inefficiencies, inconsistencies, and the risk of human error. These problems become particularly pronounced in environments where data science, engineering, and operational teams need to collaborate on machine learning model development and deployment.

For implementation of an end-to-end data life cycle pipeline in a production environment, a user is required to have knowledge of several software applications, and the user may not utilize all of the functionalities of the various software applications.

The need exists for automating the manual aspects of data lifecycle management, providing a standardized method for creating and deploying pipelines that can be scaled as needed. This reduces the operational burden on teams, while ensuring that pipelines are consistent, reliable, and easily reproducible.

The need exists for solutions that templatize data lifecycle to make data science easier or change the existing data science life cycle in any user-specified way. There's also a need to templatize and productionize the data science outcomes by converting it into a reusable and easily scalable solution.

There is a need for a data life cycle templatization engine and framework that does not require significant expertise to fully utilize the tools effectively or require users to understand the intricacies of the tool to effectively use them. There is a further need for reusable templates that can be rapidly developed and deployed for use in diverse industries and for diverse analytics problems. There is also a need for templates that is not in the form of ad hoc server or user interface code, is completely disassociated and is an independent writable entity that a platform may parse and use.

### SUMMARY OF THE INVENTION

The inventive concepts overcome the disadvantages of the prior art and fulfills the needs noted above by providing a system and method for automated templatization of an entire data lifecycle and deployment of enterprise Artificial Intelligence (AI) solutions.

An inventive concept includes a Data Life Cycle Templatization (DLT) engine and framework that encompasses the entire data life cycle including data source monitoring, visualization, and alerting. This holistic approach ensures that all aspects of data management are addressed comprehensively.

An inventive concept includes a DLT engine and framework providing reusable templates that can be applied across various industries and analytics problems. The templates are disassociated, independently writable entities that may be parsed and utilized by the platform to promote ease of use and scalability.

An inventive concept includes a DLT engine and framework which is a plugin-based architecture that allows for a lightweight, modular approach to data management. This architecture ensures that the platform can be easily extended and customized to meet specific needs without the bloat and complexity of traditional monolithic solutions. The DLT framework operates as a lightweight library and by providing pre-built solutions that can be rapidly adapted to specific use cases, the DLT engine eliminates the need for extensive engineering and data science resources for a client and thus ensuring a quicker time-to-value proposition for the client.

An inventive concept includes a DLT engine and framework that incorporates DataOPS methodologies and AI algorithms including machine learning, predictive analytics, and LLM-based user interfaces to transform maintenance strategies, optimize supply chains, and modernize data ecosystems. The modular architectures and plugin-based designs ensures seamless integration with existing infrastructures and optimizes the use of existing on-premises resources, keeping third-party cloud costs in check while accommodating a wide range of use cases.

The inventive concepts provide several advantages including, but not limited to, reducing human errors and enhancing operational efficiency with AI-driven automation; transforming maintenance strategies from reactive to proactive, reducing downtime and extending machinery lifespan; turning SCADA data into actionable insights for optimized operations and smarter decision-making, delivering intelligent rationalization between alerts and alarms; and employing custom Large Language Models to predict failures, interaction with data sources and quick insight generation, optimizing processes, and generating synthetic data for improved decision-making and innovation.

Other features and advantages of the inventive concepts will become apparent from the following description of the invention, which refers to the accompanying drawings.

### BRIEF DESCRIPTION OF THE DRAWINGS

FIG. 1 illustrates a schematic diagram of a data life cycle;

FIG. 2A illustrates a resource versioning methodology of a data life cycle templatization (DLT) engine in accordance with an embodiment of the inventive concepts;

FIGS. 2B-2C illustrate a DLT Template Resources flow, and a DLT flow, respectively, of a DLT engine and framework in accordance with an embodiment of the inventive concepts; and

FIGS. 2D-2J illustrate the workflow of datastore, feature store, inference store, metrics computation, experiment, dashboard, alert and notification, respectively, of a DLT engine and framework in accordance with an embodiment of the inventive concepts.

### DETAILED DESCRIPTION OF THE PREFERRED EMBODIMENTS

Disclosed embodiments relate to a Data Life Cycle Templatization (DLT) engine and framework and methods of using the same.

The terminology used herein is for the purpose of describing particular embodiments only and is not intended to limit the invention. As used herein, the singular terms “a,” “an,” and “the” are intended to include the plural forms as well, unless the context clearly indicates otherwise.

The term “cloud computing” is defined as a model for enabling convenient, on-demand network access to a shared pool of configurable computing resources (such as networks, servers, storage, applications, and services) that can be rapidly provisioned and released with minimal management effort or service provider interaction. Also, any system providing access via the Internet to processing power, storage, software or other computing services, often via a web browser.

The term “computer-readable storage medium” or “computer-readable storage media” is intended to include any medium or media capable of storing data in a machine-readable format that can be accessed by a sensing device and capable of converting the data into binary format. Examples include, but not limited to, floppy disk, hard drive, zip disk, tape drive, CD-ROM, CD-R, CD-RW, DVD-ROM, DVD-RW, blu-ray disc, USB flash drive, RAM, ROM, solid state drive, memory stick, multimedia card, CompactFlash, holographic data storage devices, minidisc, semiconductor memory or storage device, or the like.

The term “machine learning” or “ML” is defined as a subfield of artificial intelligence which is broadly defined as the capability of a machine to imitate intelligent human behavior, or the field of study that gives computers the ability to learn without explicitly being programmed.

The term “supervised learning” is defined as a subcategory of machine learning and artificial intelligence and is a machine learning approach defined by its use of labeled datasets to train or supervise algorithms to classify data or predict outcomes accurately. Supervised learning methods may be classification or regression.

The term “unsupervised learning” is defined as a machine learning approach that uses machine learning algorithms to analyze and cluster unlabeled datasets and these algorithms discover hidden patterns in data without the need for human intervention. Unsupervised learning models may use learning techniques such as clustering, association or dimensionality reduction.

The term “labeled dataset” is defined as a designation for pieces of data that have been tagged with one or more labels identifying certain properties or characteristics, or classifications or contained objects.

The term “deep learning” is defined as a type of machine learning based on artificial neural networks in which multiple layers of processing are used to extract progressively higher level features from data.

The term “DataOPS methodology” is defined as a methodology that uses Agile, Lean, and DevOPS principles to automate and streamline the entire data lifecycle.

The term “MLOps” (Machine Learning Operations) is defined as a methodology that applies DevOps principles to machine learning (ML) lifecycle, and are a set of practices that combine machine learning (ML), software engineering, and data engineering to streamline ML models' development, deployment, and maintenance in production environments.

The term “cloud computing” is defined as a model for enabling convenient, on-demand network access to a shared pool of configurable computing resources (such as networks, servers, storage, applications, and services) that can be rapidly provisioned and released with minimal management effort or service provider interaction. Also, any system providing access via the Internet to processing power, storage, software or other computing services, often via a web browser.

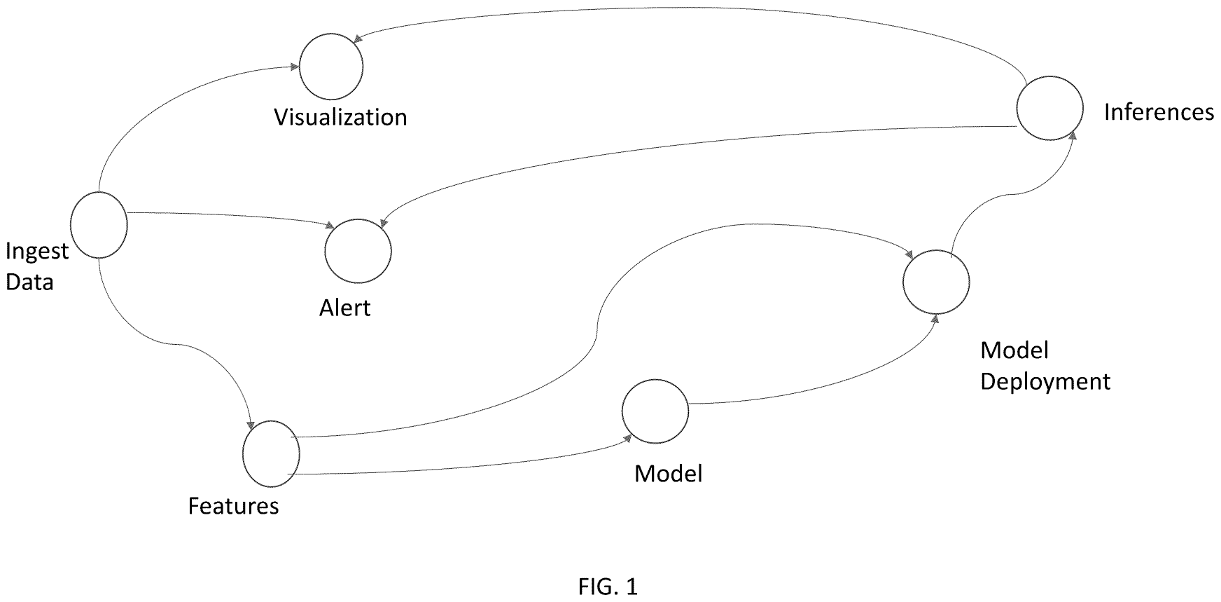

Referring to FIG. 1, a data life cycle may begin by ingesting data, followed by creation of alerts and/or visualization. The ingested data may be transformed to create features and these features may be used to create AI model(s) and/or to train the model(s). Subsequent to training the AI model(s), it is deployed and a subset of features may be provided to the deployed model(s) to create inferences. These inferences may then serve as an input to the visualization and/or alert systems.

DLT templatization extracts the components of each of the nodes shown in FIG. 1, and an underlying NIX engine handles the orchestration and connection of each of the components shown in FIG. 1. A set of configurations written in a language specific to the NIX engine (for example, C++, Rust, Python, Perl or the like) is used to create a data life cycle template and the NIX engine ingests the data life cycle template to manage and/or orchestrate the entire data life cycle.

Data Lifecycle Templatization (DLT) is a comprehensive framework designed to automate, manage, and standardize the various stages of the data lifecycle in modern data engineering, data science, and machine learning (ML) operations. DLT introduces a declarative, standardized, and low-code methodology for defining and managing end-to-end data pipelines, enabling organizations to efficiently handle the complexity of data ingestion, transformation, model deployment, monitoring, and operationalization.

Data Lifecycle Templatization (DLT) represents a transformative approach to managing the complexities of modern data workflows. By offering a low-code, declarative framework for building scalable and standardized data pipelines, DLT simplifies data management while providing the flexibility needed for large-scale deployments in diverse environments. With its focus on automation, scalability, and integration with MLOps practices, DLT ensures that organizations can efficiently manage their data lifecycle while remaining agile and prepared for future technological advancements.

This framework integrates essential components from the Data Science Lifecycle, Data Lifecycle, and MLOps methodologies to automate workflows and ensure consistency, scalability, and infrastructure-agnostic capabilities. DLT is particularly designed for use in scalable data environments where enterprises need to manage complex and large-scale data operations, offering both horizontal and vertical scaling as required.

The DLT framework operates as a declarative system in which users define what they want the final state of the data pipeline to look like rather than specifying each manual step of the process. This is achieved through standardized templates, which are low-code and customizable, allowing for reusable, versioned, and exportable workflows. These templates provide a structure for automating key processes involved in the data lifecycle, including but not limited to: (1) Data Ingestion and Preparation: Standardized templates allow users to define data sources, connections, and ingestion processes. (2) Model Training and Deployment: Templates provide mechanisms for defining model artifacts, deployment configurations, and training workflows, integrated with feature stores and inference mechanisms. (3) Monitoring and Visualization: DLT enables templated monitoring of model performance, data metrics, and visualization dashboards to track and maintain the lifecycle.

DLT also integrates seamlessly with modern MLOps practices by allowing automated retraining and deployment of machine learning models upon performance degradation or other key triggers. The DLT methodology offers a declarative, exportable, and standardized system for automating the lifecycle of data pipelines. It leverages MLOps principles to support continuous deployment, monitoring, and retraining of machine learning models while automating manual processes to reduce operational overhead.

In an embodiment of the inventive concepts, the core functionalities of the DLT framework may include the following: (1) Declarative Configuration: Users define the desired outcome of their data pipelines using declarative configurations without specifying individual implementation steps, reducing the need for extensive manual coding. This ensures simplicity while retaining flexibility for advanced customizations when needed. For example, YAML (YAML Ain′t Markup Language) and JSON (JavaScript Object Notation) are used for defining configurations in cloud-native environments like Kubernetes; HCL (HashiCorp Configuration Language) is used by HashiCorp tools like Terraform; CSS (Cascading Style Sheets) for visual presentation of webpages; and SQL for relational databases. (2) Standardized and Versioned Templates: Templates within DLT are standardized, ensuring consistency across different projects and teams. Each template is versioned, allowing for precise tracking of changes and facilitating reproducibility. (3) Low-Code Interface: The system is designed to minimize the need for extensive coding, allowing users from different backgrounds to define, manage, and deploy data pipelines with ease. This makes it accessible to a wider range of users. (4) Pluggable Architecture: DLT supports a modular, pluggable architecture, enabling the seamless addition of plugins to extend functionality, such as connectors for various data sources or notification systems. It enables DLT to be scaled vertically or horizontally depending on system demands. (5) Scalability: The DLT framework supports both vertical and horizontal scaling, allowing pipelines to scale efficiently as data loads and processing demands grow. (6) Infrastructure-Agnostic Deployment: DLT is infrastructure-independent, capable of being deployed across a variety of environments, including cloud platforms, on-premises data centers, and hybrid configurations.

In an embodiment of the inventive concepts, the DLT framework consists of several core components, each representing a key phase of the data lifecycle. First, the data ingestion and preparation phase include: (a) Datastores: Datastores are templates define the schema of the data to be ingested, specifying what data is required and how it will be structured. (b) Connection(s): Connection(s) is/are configuration(s) that define(s) how DLT connects to various data producers. (c) Datasources: Datasources are links that associate connection(s) with the appropriate datastore(s).

Second, the monitoring and visualization phase include: (a) Metrics: Metrics are templates for creating metrics, defined as SQL transformations on top of existing data, which enable real-time data monitoring. (b) Alerts: Alerts are configurable conditions on metrics that can trigger notifications based on specific criteria. (c) Dashboards: Dashboards are configurable visualization dashboards for presenting data metrics, charts, and other insights.

Third, the training, testing, deployment and inference phase include: (a) Feature Store: Feature Store are templates for incrementally storing transformed data from datastores. (b) ModelDefinition: Model Definition are configurations defining the parameters, inputs, and outputs of a machine learning model. (c) ModelArtifact: Model Artifact is a binary file supporting the model's deployment. (d) ModelDeployment: Deployed model, accessible as a REST API or similar service. (e) Experiment Management: Experiment Management are templates for running and managing experiment trials and comparing model performance. (f) Inference Jobs: Inference Jobs are templates for running periodic inference jobs on deployed models.

Finally, in industrial use cases, there may be an optional phase, Asset Framework, that includes Asset Metadata that are configurations that link assets, such as physical infrastructure or equipment, with corresponding data stored in datastores, feature stores, or inference stores.

One of the key DLT components is DLT Resources which maybe Non-Declared Resources or Declared Resources. Declared resources are part of the template whereas non-declared resources are created by the underlying implementation (DLT Engine) to combine declared resources together. Declared resources include, but not limited to, Datastores, Metrics, Alerts, Dashboards, Feature Store, Model Definition, and Inference Store. Non-declared resources include, but not limited to, Model Artifact, Inference, Experiment, Experiment Run, Model Deployment, Notification Group, Connections, and Datasources.

In an embodiment of the inventive concepts, the proposed schema for declared resources includes a Key, a unique identifier under a given scope for any declared resource this key must comprise of only alphanumeric words with maxlength 255. It further includes an Extended JSONSchema, the schema of the storage definitions in DLT is defined using an extended version of JSONSchema. It has a metadata field that can be used to define additional information about the properties, for example, isPrimaryKey, isSecret, datetimeFormat etc. The metadata field also allows user to define data consistency fields as a sanity check, for example, min, max.

An Example Extended JSONSchema: A schema for a table with not null field timestamp that is a primary key and pressure which must be between 1000 and 0.

```
{
  “type”: “object”,
    “properties”: {
          “timestamp”: {
              “type”: “string”,
              “format”: “date-time”,
              “metadata”: {
                  “isPrimaryKey”: true
              }
        },
        “pressure”: {
            “type”: “number”,
            “metadata”: {
                “validations”: {
                    “max”: 1000,
                    “min”: 0
                }
            }
      }
  },
  “required”: [“timestamp”]
}
```

Stored Referenced SQL: Transformations in DLT are defined through ANSI SQL, to define things like joins, unions, intersections etc. we may need to reference more than one stores, even a mixture of different types of stores, for example, inferencestore, featurestore and datastore. The underlying interface that queries the stored data may have the table names mapped to the actual entities of a template's instantiated workspace differently. There is a need to abstract this actual table name mapping while still taking ANSI SQL for transformations. The stores are referenced as store_type:key ie. featurestore:featurestore key. It is the underlying engine's responsibility to map it accordingly by interpreting it. A sample StoreRefSQL may look like: Select average pressure for last 100 rows from a datastore with its key as pressure_datastore.
SELECT AVG(pressure) FROM datastore:pressure_datastore ORDER BY timestamp DESC LIMIT 100
   Checkpoint Reference: A checkpoint is an externally tracked variable which holds the last value for a fetched set of ordered data. For example, for a datastore with timestamp (pkey), pressure if returned values are [[1, 2], [3, 4]] the checkpoints would be [3, 4]. The checkpoints can be referenced in the StoreRefSQL using _checkpoint_<fieldname>, for example, _checkpoint_pressure.

Template is the base configuration that defines a namespace for declared resources, it is identified by a “key” that is unique across the global scope of published DLT templates on a DLT Engine.

In an embodiment of the inventive concepts, the DLT framework includes the following schema with the properties as described below: Base Schema, Datastore Schema, Featurestore Schema, Inferencestore Schema, Metrics, Alerts, Dashboard, Model Definition.

Base Schema: Each declared resource should have a “key” which is unique under the scope of a given template. This key helps in creating a DRN (DLT resource names) as template_key:resource_key. A declared resource is versioned as well as a particular version's DRN is defined as template_key:resource_key:version where version is a monotonically increasing counter which may or may not have constant step size.

Datastore Schema: (i) Key (ii) dataSchema: ExtJSONSchema (iii) dataSchema will have a mandatory field _datasource_id_ to map the datasource at row level that was used to insert (it should be a field added by the engine)

Featurestore Schema: (i) Key (ii) dataSchema: ExtJSONSchema (iii) transformSQL: StoreRefSQL (iv) checkpointFields

Inferencestore Schema: (i) Key (ii) dataSchema: ExtJSONSchema (iii) dataSchema will have a mandatory field _model_deployment_id_ to map the inferring model at row level. (it should be a field added by the engine)

Metrics: (i) Key (ii) transformSQL: StoreRefSQL (iii) valueSchema: (iv) ExtJSONSchema (schema of the value produced by transformSQL—can optionally be auto generated by engine from transformSQL analysis) (v) paramsSchema: ExtJSONSchema (schema of the parameters that transformSQL can take—can optionally be auto generated by engine from transformSQL analysis)

Alerts: (i) Key (ii) conditionSQL: StoreRefSQL (iii) If conditionSQL returns a non NULL result then alert is raised. The rest of the fields would be used as the alert's state which can be used to send the information about the raised alert and remove repeating alerts (iv) For example, to raise an alert if pressure exceeds 1000 psi.
SELECT timestamp, pressure FROM datastore:pressure_data WHERE pressure >1000 ORDER BY timestamp LIMIT 1

Dashboards: (i) Key (ii) charts: ArrayOf<{chartRenderConfig}> (iii) chartRenderConfig references to metrics.

Model Definition: (i) Key (ii) src/: (a) Configs: (1)

ModelTrainingInputSchema (2) ModelPredictionInputSchema (3) ModelOutputSchema (4) ModelParamsSchema. (b) Definition: Implementation of model including train, test, load and predict methods.

In an embodiment of the inventive concepts, the DLT framework includes a resource versioning methodology. The version feature of the framework allows user to make changes to the resource configuration and store them as different versions, enabling the user to revert to previous versions as needed. This versioning occurs at the template resource level, allowing users to select a specific version for each resource. However, because changes in the template are interdependent, it becomes necessary to update the versions for all related resources to ensure the system functions correctly (for example, changes in data schema affecting dashboards, datastores, feature stores, etc.).

A more effective approach would be to enable users to switch versions at the use case (template) level instead of the resource level. A use case version would store a mapping of the latest resource versions associated with that use case. When switching use case versions, the framework would automatically update the corresponding resource versions based on this mapping. This approach would eliminate the need for manual version updates for each resource, thereby reducing the likelihood of version-related errors.

### The Versioning Steps Include:

| | |
|---|---|
| 1. | Template.publish( ) / template.patch( ) |
| 2. | Unpack template |

| | |
|---|---|
| a. | template_version = template.create_version( ) |
| b. | For resource in resources: |

| | |
|---|---|
| i. | If template.push_method == publish: |

| | |
|---|---|
| 1. | Resource_version = resource.create_new_version( ) |

| | |
|---|---|
| ii. | Else if template.push_method == patch: |

| | |
|---|---|
| 1. | latest_resource_version = resource.get_latest_version( ) |
| 2. | Resource_version = resource |
| 3. | If check_diff(latest_resource_version, resource): |

a. Resource_version = resource.create_new_version( )

| | |
|---|---|
| iii. | template_version.link(resource_version) |

In an embodiment of the inventive concepts, the DLT framework has an architecture and system components as follows: (1) DLTDB: It's an SQL query able OLTP storage that stores the DLT resource versions and other DLT engine specific information including user information and rbac roles. (2) Data Sink: It's an SQL query able OLAP storage that holds data of different types of stores, for example, featurestores, datastores and inferencestores for all the workspaces. (3) Facade API: Facade API exposes the DLT engine to the DLT frontends (Viewer and Editor) and the API communicates with metrics, miserver and scheduler's APIs and translates them into responses understandable by DLT frontends (Viewer and Editor). (4) Metrics API: Receives as input metric key and workspace id and computes corresponding metric by communicating with the data sink through data sink interface. The API is used by dashboards for fetching chart rendering data. The API is called by Facade API. (5) MLServerd: Loads model deployments and provides inference endpoints. It's called by Facade API and Inference jobs through scheduler workers. (6) Scheduler: Provides asynchronous and long running jobs capability through a distributed task queue. Data pull in data sources, notification sending, alert evaluation and any such logic that can cause i/o or compute block is executed on workers managed by this scheduler service. (7) RBAC Service: Depending on scalability of the DLT implementation RBAC service may be coupled with Facade API or as a stand-alone. RBAC Service associates permissions with DLT resource types and maps them to users on workspace level. (8) Admin Service: It should be spun up on as-needed basis and is used for administration for a deployed DLT engine, provides following services (and others): (a) manage users (b) manage and observe services (e.g., Metrics Server, Facade API, ML Server, Scheduler) (c) manage deployment settings (e.g., Logos, Platform settings, feature toggles) (d) manage deployed models (e) manage scheduler workers (f) manage Installed Templates. (9) DLT Viewer Frontend: Allow template consumers to use admin service installed templates in a DLT engine to be used for creation of workspace. It allows management of workspaces and allows RBAC for workspaces. It depends on Facade API Service. (10) DLTEditor Frontend: Allows editing a template through UI and provides a drag and drop interface for creating and linking DLT resources. User can pack and publish/patch a template directly from UI and does not depend on any other service for creating or editing a template. It depends on Facade API service for pushing or patching a template. (11) CLI interface: Provides fine grained control of Admin and Editor Service functionalities and is used as a single entry point for deployment of all services. It contains utility commands for creating instances of supporting third party services (e.g., databases, caches, etc.)

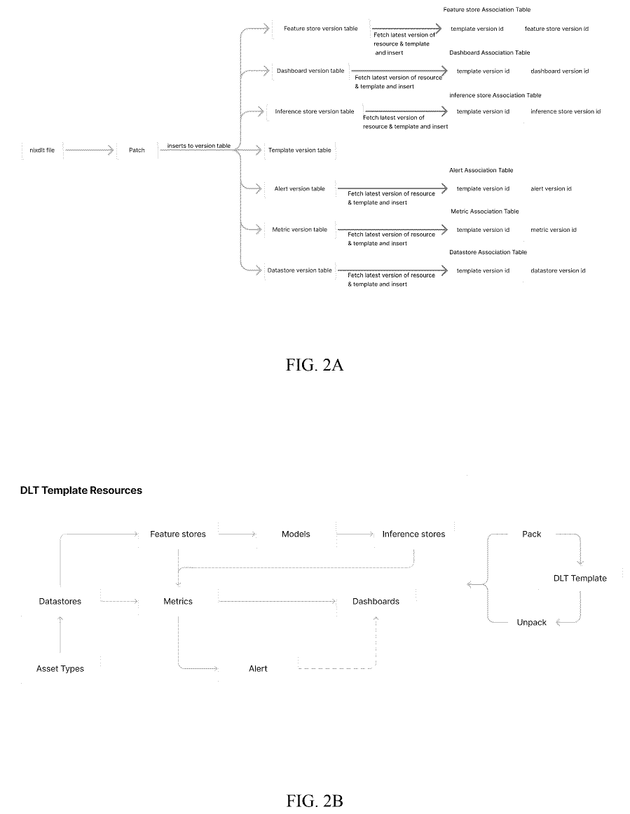

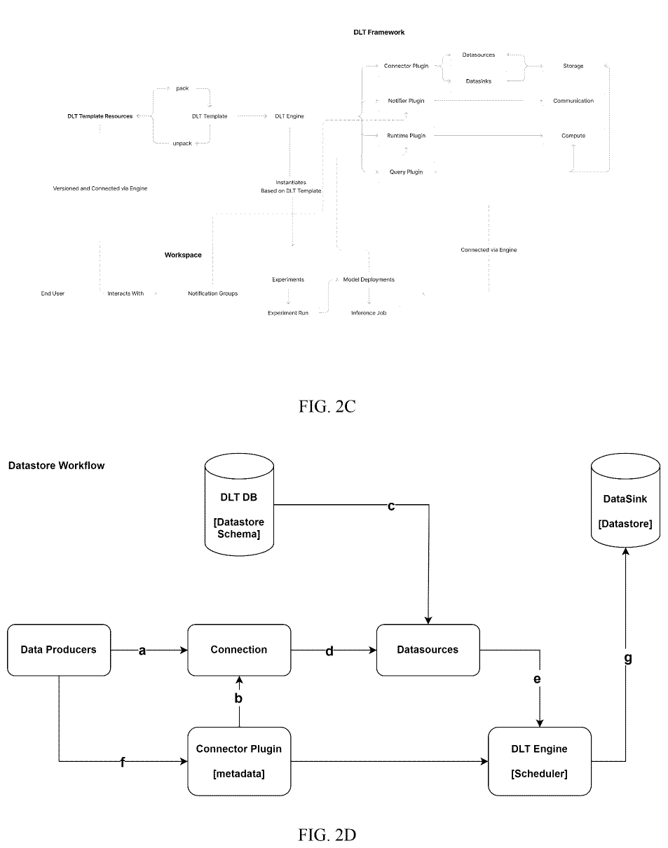

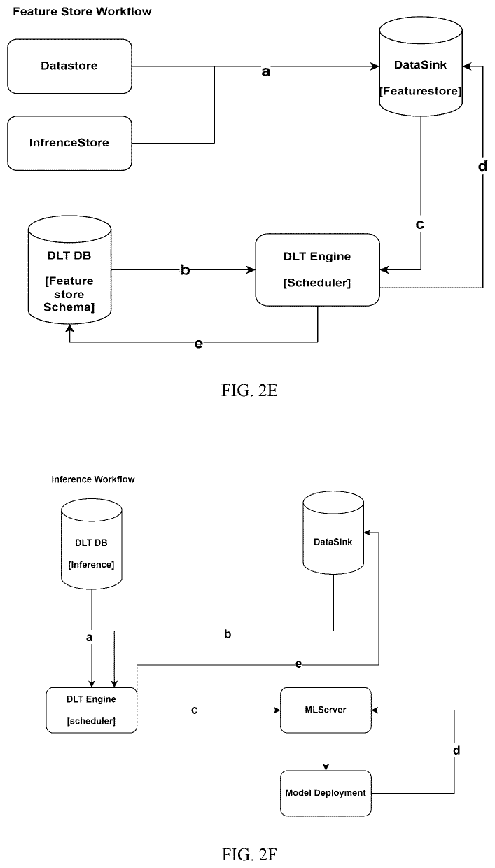

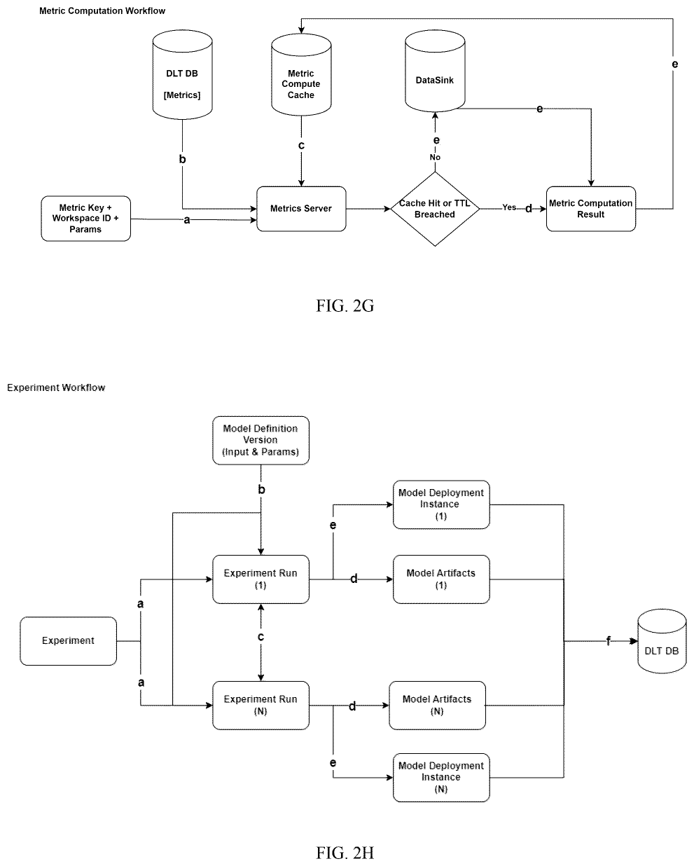

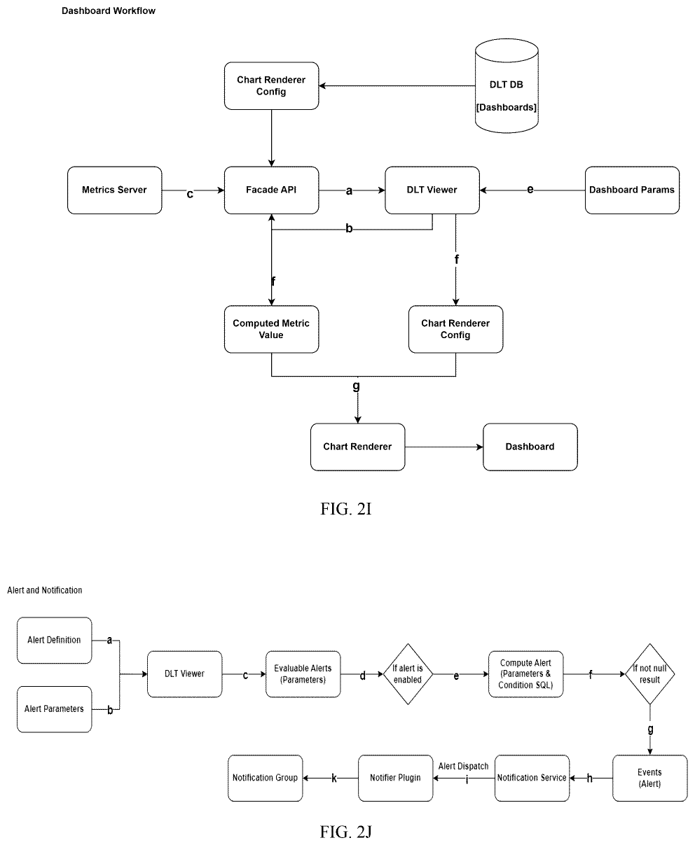

FIG. 2B-2C shows the DLT Template Resources, DLT Framework and Workspace. FIG. 2B shows how a resource is referencing other resources in a packed DLT template. FIG. 2C shows the interactions between the components. The DLT Template Resources may consist of data stores, asset types, feature stores, metrics, models, alert, inference stores, and dashboards. Data stores contain data, feature stores get input from the data stores, metrics may be generated from the data stores and feature stores, feature stores may provide input to the models, the models may be used to create inferences which are stored in the inference stores. The inferences may be provided as an input to the metrics and the metrics may be utilized to create alerts and/or dashboards. The data stores may also be associated with an asset type. The asset type may be for example, a rig or a well that may have certain data associated with the asset. The configurations of all of the DLT Template Resources may be packed into a single file, the DLT Template that may be ingested by the DLT Framework.

Referring to FIG. 2D, a datastore workflow of a DLT engine and framework in accordance with an embodiment of the inventive concepts is illustrated. A connection is created to fetch data[a] from data producers, the configuration is received[b] from the metadata of connector plugins. Datastore schema is fetched[c] from DLT DB for workspace's corresponding datastore version. Data schema and connection is combined with pull interval and other fetch specific configurations through a datasource[d]. Datasource configuration is picked up[e] as a job by the data engine's scheduler and corresponding connector plugin fetches the data[f] and the data is pushed[g] through transform sql into the data sink for the workspace's datastore.

Referring to FIG. 2E, a feature store workflow of a DLT engine and framework in accordance with an embodiment of the inventive concepts is illustrated. Datastore and Inference Store pushed the transformed data into data sink[a]. DLT Engine's scheduler fetches[b] feature store configuration from DLT DB. Scheduler's job runs the transformSQL query with checkpoints and sends the request to Data Sink and returns [c] corresponding data for storing in feature store in datasink[d] along with checkpoints that can be persisted[e] in the DLT DB.

Referring to FIG. 2F, an inference store workflow of a DLT engine and framework in accordance with an embodiment of the inventive concepts is illustrated. A inference job is defined as a combination of a transform SQL and model deployment id. DLT Engine's scheduler picks up inference job from DLT DB[a]. Inference job picks up prediction features[b] from transform SQL through datasink interface and calls ML Server's predict endpoint[c] with model deployment id. ML server responds with the prediction[d] and inference job stores the predictions in inference store[e] with the model deployment id.

Referring to FIG. 2G, a metric computation workflow of a DLT engine and framework in accordance with an embodiment of the inventive concepts is illustrated. A metric is defined as just a transform SQL. Metric Key, params and workspace id is sent to Metric Server[a]. Metric Server fetches metric definition from DLT DB with Metric Key and Workspace ID. Metric server looks into metric compute cache corresponding to cache id created based on metric_key, params and workspace_id[c], (i) if it finds it and the TTL is not over then it sends the cached value[d]; (ii) Else the query is performed on the data sink the response is cached and then the value is returned.

Referring to FIG. 211, an experiment workflow of a DLT engine and framework in accordance with an embodiment of the inventive concepts is illustrated. An experiment[a] is created as a namespace for a related set of experiment runs[a]. A model definition version and its corresponding inputs and params are supplied to create an experiment run[b]. Multiple experiment runs[a] are created and their resulting common metrics are compared[c]. As a result of each experiment run optionally model artifacts are also created[d] which are stored corresponding to a model deployment[e] instance in DLTDB[f].

Referring to FIG. 21, a dashboard workflow of a DLT engine and framework in accordance with an embodiment of the inventive concepts is illustrated. Dashboard config is defined as a set of metric keys and chart render configs. DLT viewer frontend picks up chart renderer config[a] through Facade API which has information about where a chart should be placed on and how should the chart utilize data for plotting. It loops through each chart config and makes the request to Metrics Service[c] through Facade API[b] to get computed value. Metrics Parameters are supplied through a mapping of dashboard parameters[e]. After getting the values it maps the computed values[f] to the chart renderers[g] defined on DLT viewer which parses the chart configs and plots the charts. A refetch interval is defined on the dashboard level which is modifiable by DLT viewer which defines when should all metrics be recomputed.

Referring to FIG. 2J, an alert and notification workflow of a DLT engine and framework in accordance with an embodiment of the inventive concepts is illustrated. Alert definition[a] is combined with the alert parameters[b] from the DLT viewer frontend and is converted into a evaluable alert[c]. Alert eval loop evaluates the alert if alert is enabled[d], with supplied parameters to the conditionSQL[e] and stores the eval result in the alert events[g] if a non-null result was returned[f]. Another notification service loops through all of the enabled alerts collects the alert events summarizes them and dispatches[h] the digest to the linked notification groups[k] through the notification plugin[i].

In accordance with an embodiment of the inventive concepts, a method is provided which includes storing an DLT templatization framework having one or more components described earlier on a data handling system, for example, a computer system hosted in the cloud or locally. One or more embodiments can make use of software running on a general-purpose computer or hosted on the cloud. The cloud may be a private cloud, community cloud, combined cloud, hybrid cloud, or any other cloud model. The cloud may have services such as Software as a Service (SaaS), which eliminates the need to install and run an application on a client machine; Platform as a Service (PaaS), which facilitates a computing platform in the cloud; and Infrastructure as a Service (IaaS), which delivers computer infrastructure such as servers, storage and network equipment on the cloud.

In general, the modules/routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention.

While the inventive concepts described herein with reference to illustrative embodiments for particular applications, it should be understood that the inventive concepts are not limited thereto. Those having ordinary skill in the art and access to the teachings provided herein will recognize additional modifications, applications, embodiments and substitution of equivalents all fall within the scope of the inventive concepts. Accordingly, the inventive concepts are not to be considered as limited by the foregoing description.

What is claimed as new and desired to be protected by Letters Patent of the United States is:

1. A Data Life Cycle Templatization (DLT) engine and framework, comprising:
a plurality set of templates,
wherein a first set of templates allow users to define data sources, connections, and ingestion processes;
wherein a second set of templates provide mechanisms for defining model artifacts, deployment configurations, and training workflows, integrated with feature stores and inference mechanisms;
wherein a third set of templates enables monitoring of model performance, data metrics, and visualization dashboards to track and maintain a data lifecycle;
wherein the templates are reusable, disassociated, independently writable entities that are parsed and utilized by a platform to promote ease of use and scalability;
wherein the DLT engine and framework operates as a lightweight library and provides pre-built solutions that can be rapidly adapted to specific use cases; and
wherein the DLT engine and framework eliminates the need for extensive engineering and data science resources for a client.

2. The DLT engine and framework of claim 1, wherein the first set of templates further comprises:
datastores to define schema of data to be ingested and how data will be structured;
connections to define how the DLT engine and framework connects to various data producers; and
datasources, the datasources being links that associate connections to corresponding datastores.

3. The DLT engine and framework of claim 1, wherein the second set of templates further comprises:
metrics to enable real-time data monitoring, the metrics being SQL transformations of existing data;
alerts, the alerts being configurable conditions on the metrics to trigger notifications based on specific criteria; and
dashboards, the dashboards being configurable visualization tools for presenting data metrics, charts, and other insights.

4. The DLT engine and framework of claim 1, wherein the third set of templates further comprises:
feature stores for incrementally storing transformed data from datastores;
model definitions, the model definitions being configurations defining parameters, inputs, and outputs of a machine learning model;
model artifact, the model artifact being a binary file supporting the machine learning model's deployment;
model deployment accessible as a REST API or similar service;
experiment management for running and managing experiment trials and comparing model performance; and
inference jobs for running periodic inference jobs on deployed models.

5. The DLT engine and framework of claim 1, further comprises: asset metadata, the asset metadata being configurations that link assets, such as physical infrastructure or equipment, with corresponding data stored in datastores, featurestores, or inferencestores.

6. The DLT engine and framework of claim 1, wherein users define desired outcome of data pipelines using declarative configurations without specifying individual implementation steps.

7. A Data Life Cycle Templatization (DLT) framework based on a plug-in based architecture for a lightweight, modular approach to data management, comprising:
a base schema, the base schema having a unique key for each declared resource and the unique key comprising alphanumeric words with maximum length of 255;
a datastore schema, the datastore schema having a mandatory field to map datasource at row level;
a featurestore schema;
an inferencestore schema, the inferencestore schema having a mandatory field to map inferring model at row level;
an alert, the alert having a conditionSQL and wherein alert is raised if conditionSQL returns a non-NULL result;
metrics; dashboards; and a model definition.

8. A method for resource versioning comprising:
storing a Data Life Cycle Templatization (DLT) engine and framework on a data handling system, the DLT engine and framework based on a plug-in based architecture for a lightweight, modular approach to data management, the DLT engine and framework comprises:
a DLT template resources, the DLT template resources including data stores, asset types, feature stores, metrics, models, alert, inference stores, and dashboards;
a DLT framework; and
a workspace,
wherein versioning occurs at template resource level, allowing users to select a specific version for each resource,
wherein the architecture ensures seamless integration with existing infrastructures and optimizes use of existing on-premises resources, keeping third-party cloud costs in check while accommodating a wide range of use cases, and
wherein DataOPS methodologies and AI algorithms including machine learning, predictive analytics, and LLM-based user interfaces transform maintenance strategies, optimize supply chains, and modernize data ecosystems.

9. The method of claim 8, wherein the data stores contain data, the feature stores get input from the data stores and provide input to models, and
wherein metrics are generated from the data stores and the feature stores, and the models are used to create inferences which are stored in the inference stores.

10. The method of claim 9, wherein the inferences may be provided as an input to the metrics and the metrics are utilized to create alerts and/or dashboards,
wherein the data stores are associated with an asset type, and wherein the asset type has data associated with an asset.

11. The method of claim 8, further comprising: packing configurations of the DLT template resources into a single DLT template file; and feeding the DLT template file to the DLT framework.

12. The method of claim 8, further comprising the steps of:
creating a connection to fetch data from data producers;
receiving a configuration from metadata of connector plugins;
fetching a datastore schema from DLT database for workspace's corresponding datastore version;
combining data schema and connection with pull interval and other fetch specific configurations through a datasource;
selecting a datasource configuration as a job by data engine's scheduler and fetching data through corresponding connector plugins; and
pushing through the data into data sink for workspace's datastore.

13. The method for resource versioning of claim 8, further comprising the steps of:
pushing transformed data from datastore and inference store into datasink;
fetching feature store configuration from a DLT DB using a DLT engine's scheduler;
running an SQL query with checkpoints using the DLT engine's scheduler and sending request to datasink and receiving corresponding data from datasink; and
storing in feature store the data received from the datasink and the checkpoints for persistence in the DLT DB.

14. The method for resource versioning of claim 8, further comprising the steps of:
selecting an inference job from a DLT DB using a DLT engine's scheduler, the inference job being a combination of a transform SQL and model deployment identifier;
selecting prediction features from transform SQL through datasink interface using the DLT engine's scheduler;
calling a ML server predict endpoint with model deployment id; and
storing predictions in inference stores with the model deployment id based on the response received from the ML server.

15. The method for resource versioning of claim 8, further comprising the steps of:
sending metric key, workspace id and params to metrics server;
fetching metric definition from a DLT DB, using the metric server, with metric key and workspace id;
searching metric compute cache using cache id created based on metric key, params and workspace id; and
performing either of the following: (a) sending cached value if cache id is found and TTL is not over, or (b) querying the data sink and returning query response.

16. The method for resource versioning of claim 8,
creating an experiment as a namespace for a related set of experiment runs;
supplying a model definition version and its corresponding inputs and params to create an experiment run;
comparing resulting common metrics of the multiple experiment runs; and
creating model artifacts and a model deployment instance in a DLT DB for each corresponding experiment runs.

17. The method for resource versioning of claim 8, further comprising the steps of:
defining dashboard config as a set of metric keys and chart render configs;
requesting computed value from metrics server via a façade API;
requesting chart render configs from a DLT viewer supplied through mapping of dashboard parameters;
mapping the computed value to chart renderers which parses the chart render configs; and
plotting a chart on the dashboard.

18. The method for resource versioning of claim 8, further comprising the steps of:
combining alert definition and alert parameters from the DLT viewer frontend and converting into an evaluable alert;
evaluating alert, if alert is enabled, with the alert parameters to the condition SQL;
storing evaluation result in alert events if a non-null result is returned; and
collecting the alert events, summarizing them and dispatching a digest to linked notification group through a notification plugin.

19. The method for resource versioning of claim 8, wherein the DLT framework further comprises:
a DLT DB, the DLT DB storing DLT resource versions and DLT engine specific information including user information and rbac roles;
a plurality of data sinks, the data sinks holding data of different types of stores including featurestores, datastores, and inferencestores;
a DLT viewer frontend, the DLT viewer frontend allowing template consumers to use admin service installed templates in the DLT engine to be used for creation of workspace;
a DLT editor frontend, the DLT editor frontend allowing editing a template and providing a drag and drop interface for creating and linking the DLT resources;
a Façade API, the Façade API exposing the DLT engine to the DLT viewer frontend and the DLT editor frontend, the Façade API pushes or patches a template from the DLT editor frontend;
a metrics API, the metrics API receives as input metric key and workspace id and computes corresponding metric by communicating with the data sink through data sink interface, and the metrics API is used by dashboards for fetching chart rendering data;
a ML Server, the ML Server loads model deployments and provides inference endpoints, and the ML Server is called by the Façade API;
a Scheduler, the Scheduler providing asynchronous and long running jobs capability through a distributed task queue;
a RBAC service, the RBAC Service associates permissions with DLT resource types and maps them to users on workspace level,
wherein the façade API communicates with the metrics API, the ML Server, and the Scheduler's APIs and translates them into responses understandable by the DLT viewer frontend and the DLT editor frontend.
